(19) United States
(12) Patent Application Publication
(10) Pub. No.: US 2015/0208255 A1
(43) Pub. Date: Jul. 23, 2015

(54) AUTOMATIC NETWORK DEVICE REPLACEMENT USING A SMARTPHONE

(71) Applicant: Adtran, Inc., Huntsville, AL (US)

(72) Inventor: R. Randall Belk, Huntsville, AL (US)

(21) Appl. No.: 14/602,080

(22) Filed: Jan. 21, 2015

Related U.S. Application Data
(60) Provisional application No. 61/930,740, filed on Jan. 23, 2014.

(51) Int. Cl. H04W 24/04; H04W 4/00; H04M 3/22

(52) U.S. Cl. CPC H04W 24/04; H04M 3/2263; H04W 4/003

(57) ABSTRACT

In a method for replacement of a failed network device in a data communication network, unique identifiers associated with the failed network device and a replacement network device are obtained using a handheld wireless device, such as a smartphone. A network management system modifies a configuration file to replace the unique identifier associated with the failed network device with the unique identifier associated with the replacement network device. The modified configuration file is then used to configure the replacement network device.

### CROSS-REFERENCE TO RELATED APPLICATION

The benefit of the filing date of U.S. Provisional Patent Application No. 61/930,740, filed Jan. 23, 2014, entitled “AUTOMATIC NETWORK DEVICE REPLACEMENT USING A SMARTPHONE,” is hereby claimed, and the specification thereof incorporated herein in its entirety by this reference.

### BACKGROUND

A digital communications network commonly includes network devices such as routers and switches. For example, in a Gigabit Passive Optical Network (GPON) an Optical Network Termination (ONT) is included at each premises, such as a home or business, where communications service is provided to users. From the perspective of a network service provider, a user may be referred to as a customer. From time to time, it may be necessary for a network service provider to initially install a network device or to replace a failing network device at a customer premises or other location. Typical procedures for installing or replacing such network devices at a customer premises or other location include the following.

In the case of an initial installation, a technician first physically (i.e., electrically and mechanically) connects the network device to the network infrastructure (e.g., cables). Then, the technician applies power to the network device. Applying power causes the network device to communicate via the network with a network management system at a network control center. Such initial communication is colloquially referred to in the art as “checking in.” The network management system responds to the network device checking in by transmitting information from a basic or initial configuration file to the network device. The network device loads this initial configuration file information. At that point, the network device is on-line on the network, ready for basic operation for its intended purpose. The technician then typically places a telephone call (i.e., a voice call) to an operator who is affiliated with the network control center. The technician provides the operator with information identifying the network device, such as a serial number printed on the device or its packaging, and may also provide the operator with information about the customer's requirements for using the network device. Instead of, or in addition to, reading the operator a network device serial number, the technician may read the operator a number or similar information that is printed on a work order with which the technician has been provided.

The operator, typically while still on the telephone with the technician, can use the network management system to confirm that the network device is on-line and that the initial configuration file has been loaded into the network device. Once the operator has confirmed this, the operator can use the network management system or a related system to create a new configuration file to be associated with the network device. This new configuration file reflects the customer's specific requirements, which may differ from those of other customers. A configuration file typically comprises a list of commands and also includes the serial number or other information identifying the network device. In response to being powered up, a network device executes the commands in the configuration file it has loaded. Typical commands in a configuration file include, for example, enabling or disabling specified interfaces in the network device. The operator instructs the network management system to associate the new configuration file with the network device, as identified by its serial number. The operator then tells the technician that the new configuration file has been associated with the network device. The technician then cycles the network device's power off and back on. The network device responds to this cycling of power by checking in with the network management system. The network management system responds to the network device checking in by transmitting information from the new configuration file to the network device. The network device receives and loads the configuration file information, thereby replacing the initial configuration file information. The technician and operator can end the telephone call. At that point, the network device is ready for operation and configured to operate in accordance with the customer's requirements.

In the case of replacing a failed device, a technician physically disconnects the failed network device from the network infrastructure and physically connects a replacement network device in its place and powers it up. The technician then may place a telephone call to an operator affiliated with the network control center. The technician tells the operator the serial number of the replacement network device in the same manner as during an initial installation.

The operator can use the network management system or a related system to make a copy of the existing configuration file for the failed network device. The operator can edit the copy to replace the serial number of the failed network device with the serial number of the replacement network device. The operator then confirms through the network management system that the replacement network device is on-line and tells the technician that the configuration file has been updated with the serial number of the replacement network device. The technician then cycles the replacement network device's power off and back on. Cycling power causes the replacement network device to check in with the network management system. The network management system responds to the replacement network device checking in by transmitting the new configuration file information to the replacement network device. The replacement network device receives and loads the new configuration file information. The technician and operator can end the telephone call. At that point, the replacement network device is ready for operation in place of the failed network device.

### SUMMARY

Embodiments of the invention relate to a method for replacement of a failed network device in a data communication network using a handheld wireless device. In accordance with an exemplary method of operation, the handheld wireless device receives a first unique identifier associated with the failed network device and a second unique identifier associated with a replacement network device. The first and second unique identifiers are then communicated from the handheld wireless device to a network management system. Using the first unique identifier, the network management system accesses a configuration record associated with the failed network device. The network management system then associates the second unique identifier with the configuration record. Then, when the replacement network device communicates (i.e., checks in) with the network management system, information from the configuration record is communicated to the replacement network device installed at the premises in place of the failed network device.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a block diagram of a system for replacement of a failed network device with a replacement network device using a handheld wireless device, in accordance with an exemplary embodiment of the invention.

FIG. 2 is similar to FIG. 1, illustrating a further aspect of operation of the system.

FIG. 3 is similar to FIGS. 1 and 2, illustrating still a further aspect of operation of the system.

FIG. 4 is similar to FIGS. 1-3, illustrating yet a further aspect of operation of the system.

FIG. 5 is a flow diagram illustrating an exemplary method for replacement of a failed network device with a replacement network device using a handheld wireless device.

FIG. 6 is a block diagram of a network management system, in accordance with an exemplary embodiment.

### DETAILED DESCRIPTION

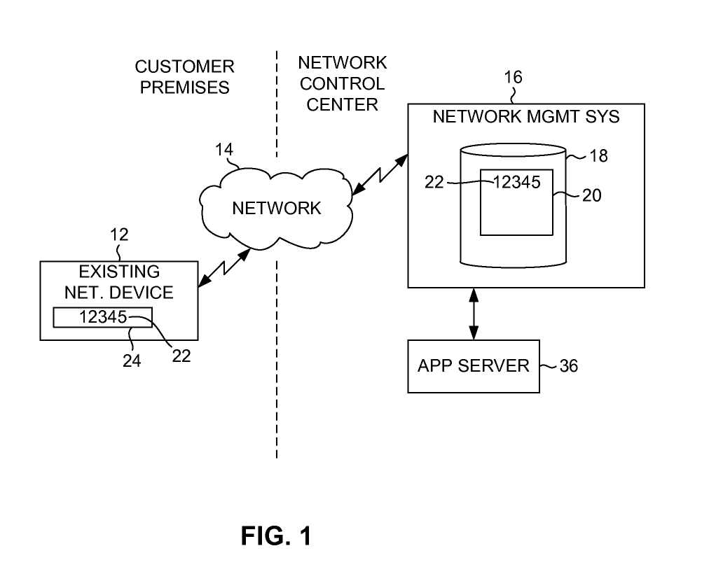

As illustrated in FIG. 1, an illustrative or exemplary embodiment of the invention relates to a scenario in which it has been determined that an existing network device 12 has failed and therefore needs to be replaced. Existing network device 12 can be any suitable type of electronic equipment, such as an Optical Network Termination (ONT), a router, switch, etc., which contributes to the operation of a digital communications network. In the exemplary embodiment, existing network device 12 is installed at a premises, such as a home or business. From the perspective of a network service provider, which is a business entity that enables its customers to access and otherwise use the network, such a premises can be referred to as a customer premises. However, in other embodiments, such a network device in need of replacement can be installed at any other suitable location.

The network service provider operates a data communications network 14 or is otherwise affiliated with providing users (i.e., customers) access to data communications network 14. Data communications network 14 can be of any suitable type, such as, for example, a Gigabit Passive Optical Network (GPON). The network service provider also operates or is otherwise associated with operating a network management system 16. Network management system 16 can be a computer-based system located at a network control center that controls various aspects of the operation of data communications network 14. Network management system 16 can include a user interface (not shown) to allow the network service provider's personnel at the network control center to control aspects of the operation of data communications network 14. Network management system 16 can also include a database 18 or similar data storage system. A configuration file 20 or similar record associated with each existing network device 12 is stored in database 18. In the exemplary embodiment, information included in configuration file 20 includes a unique identifier 22, such as a serial number, associated with existing network device 12 and a list of commands (not shown) relating to the configuration of existing network device 12. Note that in the exemplary embodiment this same unique identifier 22 is printed on a label 24 attached to existing network device 12.

Although only one existing network device 12 installed at one customer premises is shown in FIG. 1 for purposes of clarity, many such network devices can be installed at many such customer premises. All such other network devices can communicate with network management system 16 via data communications network 14 in the same manner described herein with regard to existing network device 12.

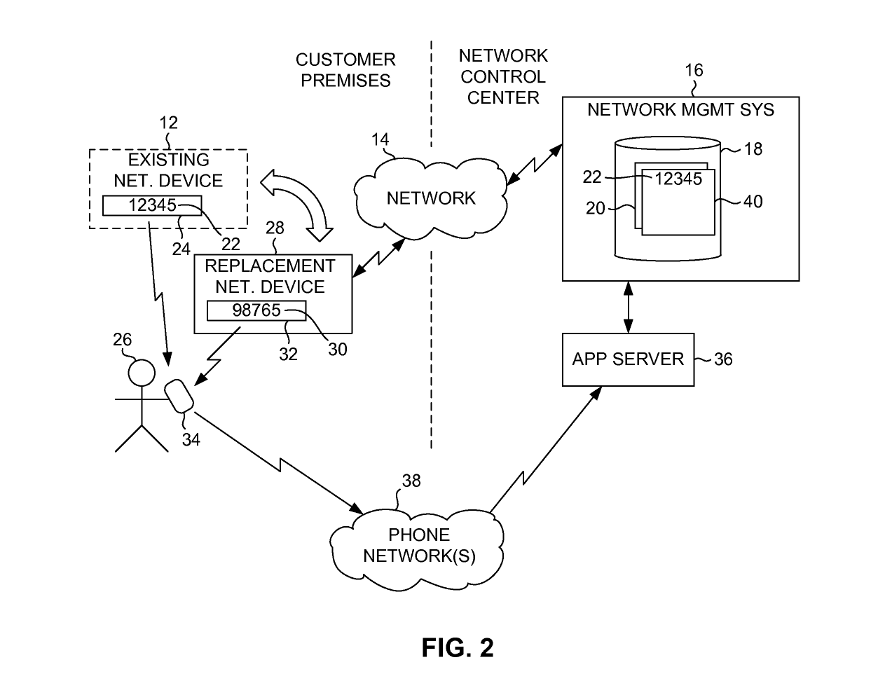

As illustrated in FIG. 2, in accordance with the exemplary embodiment a technician 26 at the customer premises has determined that existing network device 12 has failed and therefore is to be replaced with a replacement network device 28. To replace existing network device 12, technician 26 physically disconnects existing network device 12 from data communications network 14 by, for example, disconnecting power cables and data signal cables (not shown). Then, technician 26 physically connects replacement network device 28 to data communications network 14 by, for example, connecting power cables and data signal cables (not shown). Note that the serial number or other unique identifier 30 associated with replacement network device 28 is printed on a label 32 attached to replacement network device 28.

As further illustrated in FIG. 2, technician 26 uses a smartphone or similar handheld wireless device 34 to obtain unique identifiers 22 and 30 associated with existing network device 12 and replacement network device 28, respectively. For example, technician 26 can operate handheld wireless device 34 under the control of an application program or “app” (not shown) that causes handheld wireless device 34 to optically read unique identifiers 22 and 30 on labels 24 and 32, respectively. Although in the exemplary embodiment unique identifiers 22 and 30 are indicated in Arabic numerals, in other embodiments such unique identifiers can be indicated on such network devices or their packaging or associated materials in any other suitable form of indicia, such as barcodes.

Under control of the app, handheld wireless device 34 establishes communication with an application server 36 via one or more phone networks 38, which can include wireless telephone networks as well as the public switched telephone network. Under control of the app, handheld wireless device 34 transmits unique identifiers 22 and 30 to application server 36. Application server 36 causes network management system 16 to initiate a process that includes making a copy of configuration file 20. The copy can be referred to herein for purposes of clarity as the replacement configuration file 40. Although in the exemplary embodiment a separate application server 36 is shown connected to network management system 16, in other embodiments a single or integrated computer-based system can provide the functions attributed herein to both application server 36 and network management system 16. For example, a conventional network management system 16 can be modified to provide the functions described herein with regard to application server 36.

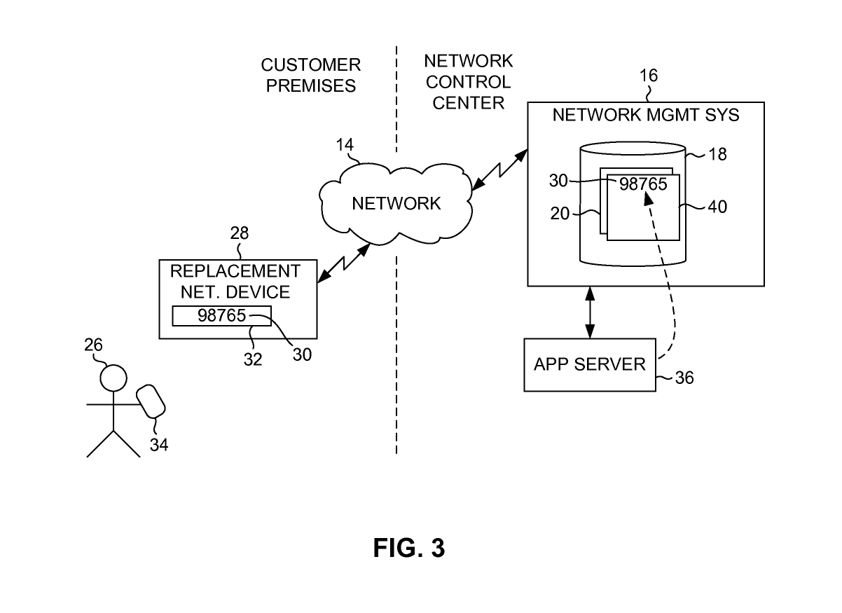

As illustrated in FIG. 3, as part of the process performed in response to the above-described interaction with application server 36, network management system 16 replaces unique identifier 22 in replacement configuration file 40 with unique identifier 30, which is associated with replacement network device 28. Network management system 16 can also create what is commonly referred to in the art as a “restore job.” As well understood by persons skilled in the art, a restore job comprises a series of commands that network management system 16 can execute. Although not shown for purposes of clarity, network management system 16 can include software elements that control the interaction with application server 36 in the foregoing manner.

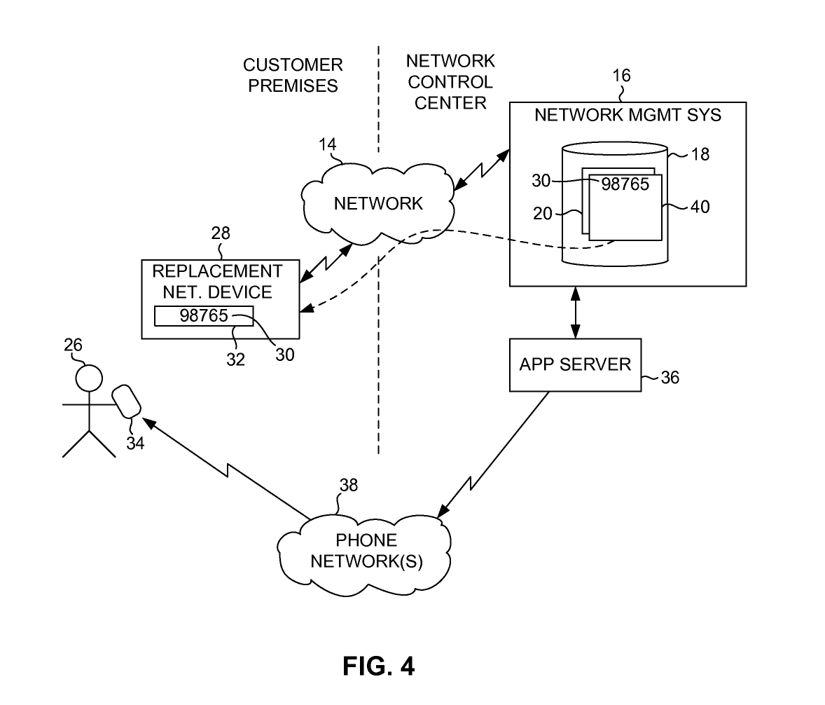

As illustrated in FIG. 4, application server 36 can determine that network management system 16 has created replacement configuration file 40, which includes unique identifier 30. When application server 36 has determined that this has been done, application server 36 causes a corresponding notification to be transmitted to handheld wireless device 34 via the one or more phone networks 38. Handheld wireless device 34 can output the notification in a form that technician 26 can perceive, such as a text display.

Technician 26 can then cycle the power to replacement network device 28 off and back on. In response to this cycling of power, replacement network device 28 checks in with network management system via data communications network 14. In response to replacement network device 28 checking in, network management system 16 executes the restore job. The restore job includes commands that cause network management system 16 to transmit some or all of the information included in replacement configuration file 40 to replacement network device 28 via data communications network 14. Replacement network device 28 responds by loading or otherwise configuring its hardware and software elements in accordance with the configuration information it receives from network management system 16. Network management system 16 can then delete configuration file 20, which was associated with existing network device 12.

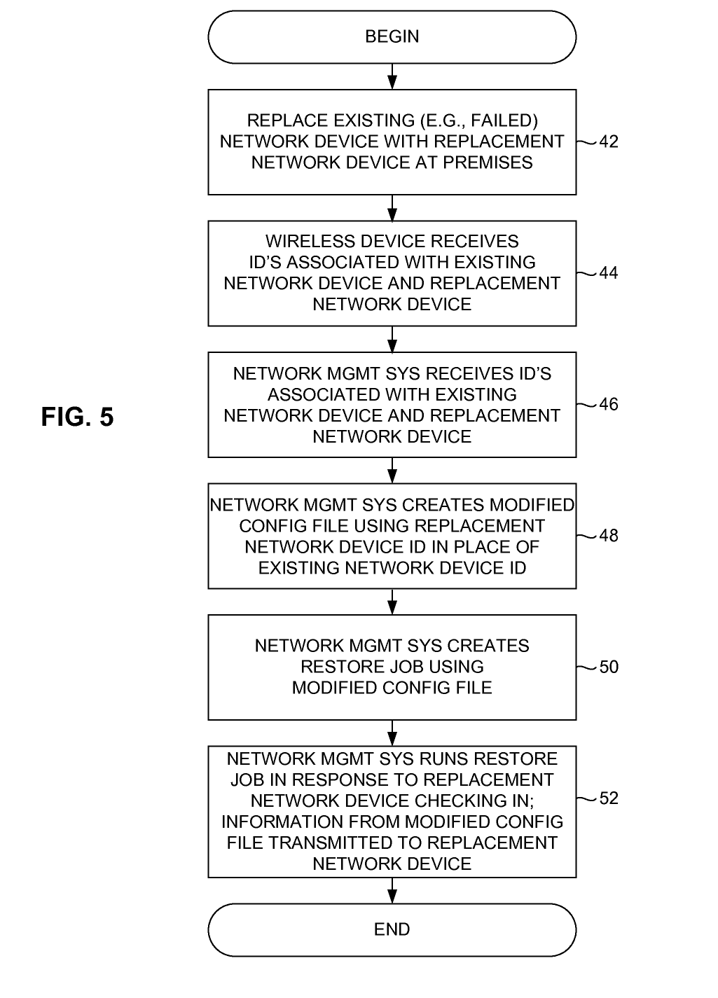

The above-described method of operation is summarized in the flow diagram of FIG. 5. As indicated by block 42, a technician at a premises at which an existing network device 12 is installed replaces existing network device 12 with a replacement network device 28. As indicated by block 44, handheld wireless device 34 receives a first unique identifier associated with existing network device 12 and a second unique identifier associated with replacement network device 28. Handheld wireless device 34 sends the first and second unique identifiers to application server 36 via phone networks 38. Application server 36, in turn, provides the first and second unique identifiers to network management system 16. As indicated by block 46, network management system 16 receives the first and second unique identifiers via the aforementioned system elements. As indicated by block 48, network management system 16 uses the first unique identifier to access a configuration record associated with the failed network device, creates a copy of the configuration record, and modifies the copy to associate the second unique identifier with the configuration record in place of the first unique identifier. As indicated by block 50, network management system 16 creates a restore job using the modified configuration record. As indicated by block 52, network management system 16 executes the restore job in response to detecting replacement network device 28 checking in with network management system 16. Execution of the restore job causes network management system 16 to transmit information from the configuration record to the replacement network device.

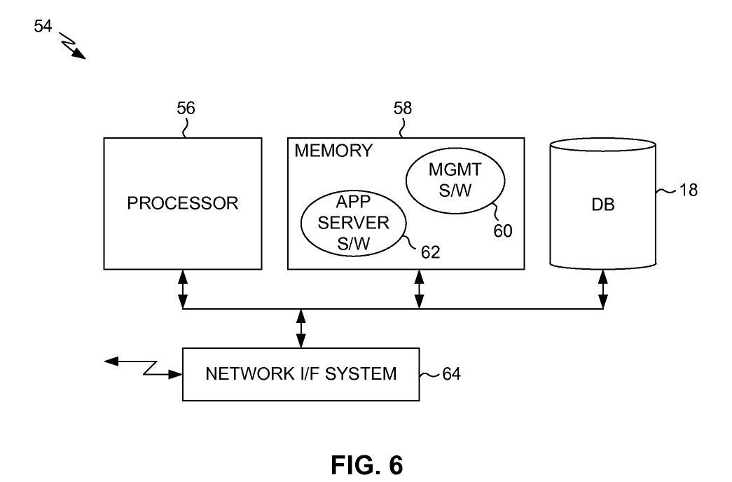

As illustrated in FIG. 6, a computing system 54 can provide the above-described aspects of network management system 16 and application server 36. Computing system 54 can include at least one processor 56, at least one memory 58, and the above-described database 18. Processor 56 is programmed or configured with a network management software element 60 and an application server software element 62. Although conceptually shown for purposes of illustration as stored in or residing in memory 58, persons skilled in the art can appreciate that such software elements need not reside in memory 58 simultaneously or in their entireties, but rather can be retrieved into memory 58 on an as-needed basis in portions such as modules, code segments, files, instruction-by-instruction, or any other suitable basis, from another source such as a non-volatile memory (not shown), disk drive (not shown), etc., in accordance with conventional computing principles. Although only network management software element 60 and application server software element 62 are shown for purposes of clarity, other software elements of the types conventionally included in computing systems that enable them to operate properly are also generally included, such as operating system software. Similarly, other hardware elements of the types conventionally included in network management systems or other computing systems can be included. It should be noted that, as programmed with the above-described software elements, the combination of processor 56, memory 58 (or other element or elements in which software elements are stored or reside) and any related elements generally defines a programmed processor system. It should also be noted that the combination of software elements and the non-transitory medium on which they are stored or in which they reside (e.g., memory 58, one or more removable or portable disks (not shown), etc.) generally constitutes what is referred to in the patent lexicon as a “computer program product.”

Application server software 62 contributes to configuring the processing system to control the above-described communications with handheld wireless device 34 via phone networks 38. Network management software 60 contributes to configuring the processing system to control the above-described accessing of database 18 and processing of the configuration records stored in database 18. Communications between computer system 54 and handheld wireless device 34 can occur via a portion of a network interface system 64 that interfaces with phone networks 38 (FIGS. 2 and 4). Communications between computer system 54 and replacement device 28 can occur via another portion of network interface system 64 that interfaces with data communications network 14 (FIGS. 1-4).

One or more illustrative or exemplary embodiments of the invention have been described above. However, it is to be understood that the invention is defined by the appended claims and is not limited to the specific embodiments described.

What is claimed is:

1. A method for replacement of a failed network device in a data communications network, the method comprising:
a network management system receiving from a handheld wireless device a first unique identifier associated with the failed network device;
the network management system receiving from the handheld wireless device a second unique identifier associated with a replacement network device;
the network management system accessing a configuration record associated with the failed network device using the first unique identifier;
the network management system associating the second unique identifier with the configuration record; and
the network management system transmitting information from the configuration record to the replacement network device.

2. The method of claim 1, wherein:
the network management system receiving the first unique identifier comprises obtaining the first unique identifier from the failed network device; and
the network management system receiving the second unique identifier comprises obtaining the second unique identifier from the replacement network device.

3. The method of claim 2, wherein:
obtaining the first unique identifier from the failed network device comprises the handheld wireless device optically scanning the failed network device; and
obtaining the second unique identifier from the replacement network device comprises the handheld wireless device optically scanning the replacement network device.

4. The method of claim 1, further comprising:
disconnecting the failed network device from a network connection; and
connecting the replacement network device to the network connection in place of the failed network device prior to the network management system transmitting information from the configuration record to the replacement network device.

5. The method of claim 1, wherein the handheld wireless device is located at a premises where the failed network device is located.

6. The method of claim 1, wherein the handheld wireless device comprises a smartphone operating under control of an application program.

7. The method of claim 1, wherein the network management system transmitting information from the configuration record to the replacement network device comprises the network management system executing a restore job.

8. The method of claim 1, wherein the network management system transmits the information from the configuration record to the replacement network device in response to the handheld wireless device checking in.

9. A system for replacement of a failed network device in a data communications network, the system comprising:
a database configured to store a plurality of configuration records, each configuration record associated with a network device;
a network interface system; and
a processing system comprising at least one processor and at least one memory, the processing system programmed or configured to control a method comprising:
establishing a communication link with a handheld wireless device;
receiving from the handheld wireless device a first unique identifier associated with the failed network device;
receiving from the handheld wireless device a second unique identifier associated with a replacement network device;
accessing a configuration record in the database associated with the failed network device using the first unique identifier;
associating the second unique identifier with the configuration record; and
transmitting information from the configuration record to the replacement network device.

10. The system of claim 9, wherein transmitting information from the configuration record to the replacement network device comprises executing a restore job.

11. The system of claim 9, wherein the processing system is programmed or configured to detect the handheld wireless device checking in, and transmitting the information from the configuration record to the replacement network device is performed in response to detecting the handheld wireless device checking in.

12. A computer program product for replacement of a failed network device in a data communications network, the computer program product comprising a computer-readable medium having stored thereon in non-transitory computer-executable form instructions that when executed by a processing system cause the processing system to control a method comprising:
establishing a communication link with a handheld wireless device;
receiving from the handheld wireless device a first unique identifier associated with the failed network device;
receiving from the handheld wireless device a second unique identifier associated with a replacement network device;
accessing a configuration record associated with the failed network device using the first unique identifier;
associating the second unique identifier with the configuration record; and
transmitting information from the configuration record to the replacement network device.

13. The computer program product of claim 12, wherein transmitting information from the configuration record to the replacement network device comprises executing a restore job.

14. The computer program product of claim 12, wherein transmitting the information from the configuration record to the replacement network device is performed in response to detecting the handheld wireless device checking in.
